(19) United States
(12) Patent Application Publication
(10) Pub. No.: US 2023/0347758 A1
(43) Pub. Date: Nov. 2, 2023

(54) METHOD FOR LOCATING CHARGING STATION USING ULTRA-WIDE BAND RADIO

(71) Applicant: FORD GLOBAL TECHNOLOGIES, LLC, Dearborn, MI (US)

(72) Inventors: Jerry JOHN, Sunnyvale, CA (US); Adam WEBER, Santa Clara, CA (US); Andre Aaron MELSON, Concord, CA (US); Michael VANN, San Francisco, CA (US)

(21) Appl. No.: 17/733,190

(22) Filed: Apr. 29, 2022

(51) Int. Cl. B60L 53/126; G08G 1/14

(52) U.S. Cl. CPC B60L 53/126; G08G 1/148; G08G 1/146

(57) ABSTRACT

A vehicle includes a plurality of vehicle transceivers; and a controller, programmed to responsive to detecting the vehicle has arrived at a predefined geofence associated with a charging facility, establish a first ultra-wide band (UWB) communication between the plurality of vehicle transceivers and a charger transceiver associated with a charger, calculate an orientation and distance of the charger from the vehicle using a timing of the first UWB communication of each of the plurality of vehicle transceivers, and maneuver the vehicle to a parking space associated with the charger based on the first UWB communication without driver input.

### TECHNICAL FIELD

The present disclosure generally relates to a vehicle communication system. For specifically, the present disclosure relates to a vehicle communication system using ultra-wide band (UWB) communications.

### BACKGROUND

Electric vehicles rely on a traction battery to provide electric power for propulsion. The traction battery may be recharged at a public charging station. In general, charging an electric vehicle takes longer time than refueling a vehicle relying on conventional fuel (e.g. gasoline).

### SUMMARY

In one or more illustrative examples of the present application, a vehicle includes a plurality of vehicle transceivers; and a controller, programmed to responsive to detecting the vehicle has arrived at a predefined geofence associated with a charging facility, establish a first UWB communication between the plurality of vehicle transceivers and a charger transceiver associated with a charger, calculate an orientation and distance of the charger from the vehicle using a timing of the first UWB communication of each of the plurality of vehicle transceivers, and maneuver the vehicle to a parking space associated with the charger based on the first UWB communication without driver input.

In one or more illustrative examples of the present application, a method for a vehicle includes responsive to setting a charging facility as navigation destination, receiving an identification of a charger transceiver associated with a charger; responsive to establishing a first UWB communication between a plurality of vehicle transceivers and the charger transceiver, calculating a distance of the charger from the vehicle using a timing of the first UWB communication of each of the plurality of vehicle transceivers; and maneuvering the vehicle to a parking space associated with the charger based on the first UWB communication without a driver input.

In one or more illustrative examples of the present application, a non-transitory computer readable medium, includes instructions that, when executed by a vehicle, cause the vehicle to perform operations including to responsive to establishing a first UWB communication between a plurality of vehicle transceivers and a charger transceiver of a charger, calculate a direction and distance of the charger from the vehicle using a timing of the first UWB communication of each of the plurality of vehicle transceivers; and maneuvering the vehicle to a parking space associated with the charger based on the first UWB communication.

### BRIEF DESCRIPTION OF THE DRAWINGS

For a better understanding of the invention and to show how it may be performed, embodiments thereof will now be described, by way of non-limiting example only, with reference to the accompanying drawings, in which:

FIG. 1 illustrates an example block topology of a vehicle system of one embodiment of the present disclosure;

FIG. 2 illustrates an example schematic diagram of the vehicle-infrastructure communication system of one embodiment of the present disclosure; and

FIG. 3 illustrates an flow diagram of a process for operating the vehicle to a charging station of one embodiment of the present disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The present disclosure generally provides for a plurality of circuits or other electrical devices. All references to the circuits and other electrical devices, and the functionality provided by each, are not intended to be limited to encompassing only what is illustrated and described herein. While particular labels may be assigned to the various circuits or other electrical devices, such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electric devices may be configured to execute a computer-program that is embodied in a non-transitory computer readable medium that is programed to perform any number of the functions as disclosed.

The present disclosure, among other things, proposes a vehicle communication system using UWB communications. More specifically, the present disclosure proposes a communication system between a vehicle and a fueling infrastructure using UWB communications.

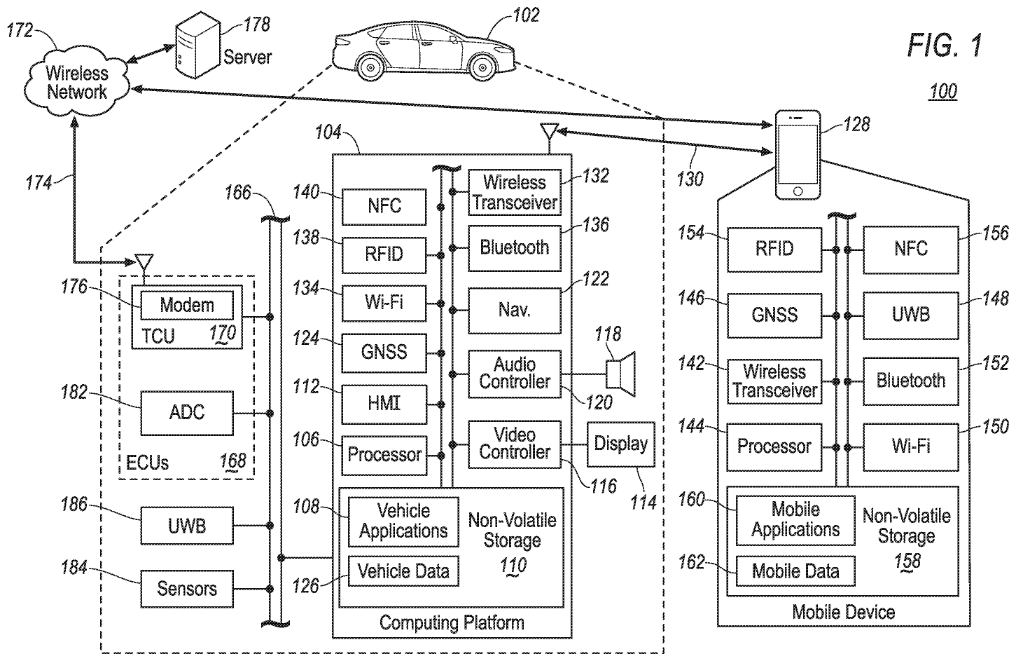

Referring to FIG. 1, an example block topology of a vehicle system 100 of one embodiment of the present disclosure is illustrated. A vehicle 102 may include various types of automobile, crossover utility vehicle (CUV), sport utility vehicle (SUV), truck, recreational vehicle (RV), boat, plane, or other mobile machine for transporting people or goods. In many cases, the vehicle 102 may be powered by an internal combustion engine. As another possibility, the vehicle 102 may be a battery electric vehicle (BEV), a hybrid electric vehicle (HEV) powered by both an internal combustion engine and one or move electric motors, such as a series hybrid electric vehicle (SHEV), a plug-in hybrid electric vehicle (PHEV), a parallel/series hybrid vehicle (PSHEV), or a fuel-cell electric vehicle (FCEV), a boat, a plane or other mobile machine for transporting people or goods. It should be noted that the illustrated system 100 is merely an example, and more, fewer, and/or differently located elements may be used.

As illustrated in FIG. 1, a computing platform 104 may include one or more processors 106 configured to perform instructions, commands, and other routines in support of the processes described herein. For instance, the computing platform 104 may be configured to execute instructions of vehicle applications 108 to provide features such as navigation, remote controls, and wireless communications. Such instructions and other data may be maintained in a non-volatile manner using a variety of types of computer-readable storage medium 110. The computer-readable medium 110 (also referred to as a processor-readable medium or storage) includes any non-transitory medium (e.g., tangible medium) that participates in providing instructions or other data that may be read by the processor 106 of the computing platform 104. Computer-executable instructions may be compiled or interpreted from computer programs created using a variety of programming languages and/or technologies, including, without limitation, and either alone or in combination, Java, C, C++, C #, Objective C, Fortran, Pascal, Java Script, Python, Perl, and structured query language (SQL).

The computing platform 104 may be provided with various features allowing the vehicle occupants/users to interface with the computing platform 104. For example, the computing platform 104 may receive input from human machine interface (HMI) controls 112 configured to provide for occupant interaction with the vehicle 102. As an example, the computing platform 104 may interface with one or more buttons, switches, knobs, or other HMI controls configured to invoke functions on the computing platform 104 (e.g., steering wheel audio buttons, a push-to-talk button, instrument panel controls, etc.).

The computing platform 104 may also drive or otherwise communicate with one or more displays 114 configured to provide visual output to vehicle occupants by way of a video controller 116. In some cases, the display 114 may be a touch screen further configured to receive user touch input via the video controller 116, while in other cases the display 114 may be a display only, without touch input capabilities. The computing platform 104 may also drive or otherwise communicate with one or more speakers 118 configured to provide audio output and input to vehicle occupants by way of an audio controller 120.

The computing platform 104 may also be provided with navigation and route planning features through a navigation controller 122 configured to calculate navigation routes responsive to user input via e.g., the HMI controls 112, and output planned routes and instructions via the speaker 118 and the display 114. Location data that is needed for navigation may be collected from a global navigation satellite system (GNSS) controller 124 configured to communicate with multiple satellites and calculate the location of the vehicle 102. The GNSS controller 124 may be configured to support various current and/or future global or regional location systems such as global positioning system (GPS), Galileo, Beidou, Global Navigation Satellite System (GLONASS) and the like. Map data used for route planning may be stored in the storage 110 as a part of the vehicle data 126. Navigation software may be stored in the storage 110 as one the vehicle applications 108.

The computing platform 104 may be configured to wirelessly communicate with a mobile device 128 of the vehicle users/occupants via a wireless connection 130. The mobile device 128 may be any of various types of portable computing devices, such as cellular phones, tablet computers, wearable devices, smart watches, smart fobs, laptop computers, portable music players, or other device capable of communication with the computing platform 104. A wireless transceiver 132 may be in communication with a Wi-Fi controller 134, a Bluetooth controller 136, a radio-frequency identification (RFID) controller 138, a near-field communication (NFC) controller 140, and other controllers such as a Zigbee transceiver, an IrDA transceiver, and configured to communicate with a compatible wireless transceiver 142 of the mobile device 128.

The mobile device 128 may be provided with a processor 144 configured to perform instructions, commands, and other routines in support of the processes such as navigation, telephone, wireless communication, and multi-media processing. For instance, the mobile device 128 may be provided with location and navigation functions via a GNSS controller 146. The mobile device 128 may be provided with a wireless transceiver 142 in communication with a UWB controller 148, a Wi-Fi controller 150, a Bluetooth controller 152, a RFID controller 154, an NFC controller 156, and other controllers (not shown), configured to communicate with the wireless transceiver 132 of the computing platform 104. The mobile device 128 may be further provided with a non-volatile storage 158 to store various mobile application 160 and mobile data 162.

The computing platform 104 may be further configured to communicate with various components of the vehicle 102 via one or more in-vehicle network 166. The in-vehicle network 166 may include, but is not limited to, one or more of a controller area network (CAN), an Ethernet network, and a media-oriented system transport (MOST), as some examples. Furthermore, the in-vehicle network 166, or portions of the in-vehicle network 166, may be a wireless network accomplished via Bluetooth low-energy (BLE), Wi-Fi, or the like.

The computing platform 104 may be configured to communicate with various electronic control units (ECUs) 168 of the vehicle 102 configured to perform various operations. For instance, the computing platform 104 may be configured to communicate with a telematics control unit (TCU) 170 configured to control telecommunication between vehicle 102 and a wireless network 172 through a wireless connection 174 using a modem 176. The wireless connection 174 may be in the form of various communication network e.g., a cellular network. Through the wireless network 172, the vehicle may access one or more servers 178 to access various content for various purposes. It is noted that the terms wireless network and server are used as general terms in the present disclosure and may include any computing network involving carriers, router, computers, controllers, circuitry or the like configured to store data and perform data processing functions and facilitate communication between various entities. The ECUs 168 may further include an autonomous driving controller (ADC) 182 configured to control autonomous driving features of the vehicle 102. Driving instructions may be received remotely from the server 178. The ADC 182 may be configured to perform the autonomous driving features using the driving instructions combined with navigation instructions from the navigation controller 122. The ADC 182 may be further configured to control a parking assist feature to autonomously operate the vehicle 102 to arrive at a parking spot using signals from various sensors 184. The vehicle 102 may be provided with various sensors 184 to provide signal input to the computing platform 104 and the ECUs 168. As a few non-limiting examples, the sensors 184 may include one or more cameras configured to capture images from the vehicle. The sensors 184 may further include one or more ultra-sonic radar sensors and/or lidar sensors to detect object at the vicinity of the vehicle 102. In addition, the vehicle 102 may be further provided with a UWB transceiver 186 configured to communicate with various entities using UWB communications. For instance, the vehicle 102 may be configured to communicate with one or more charging infrastructures via the UWB transceiver 186.

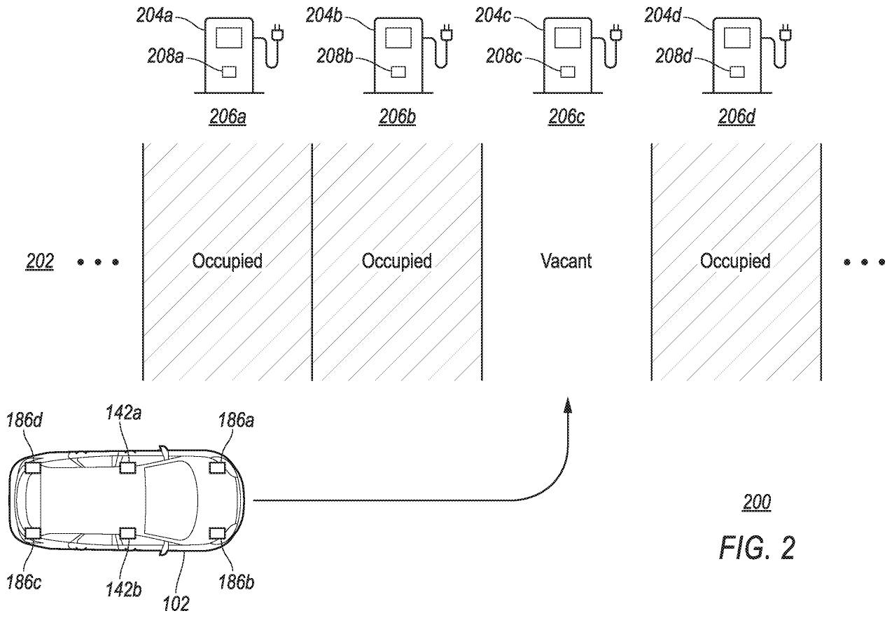

Referring to FIG. 2, an example schematic diagram 200 of the vehicle-infrastructure communication system of one embodiment of the present disclosure is illustrated. With continuing reference to FIG. 1, the vehicle 102 in the present example may be provided with a plurality of UWB transceivers 186 at different locations of the vehicle 102. For instance, the vehicle 102 may be provided with a first UWB transceiver 186a located near a front-left corner of the vehicle 102. The vehicle 102 may be further provided with a second UWB transceiver 186b located near a front-right corner of the vehicle 102. The vehicle 102 may be further provided with a third UWB transceiver 186c located near a rear-right corner of the vehicle 102. The vehicle 102 may be further provided with a fourth UWB transceiver 186d located near a rear-left corner of the vehicle 102. It is noted that locations of the vehicle UWB transceivers 186 in the present example are only for demonstrative purpose and one or more of the UWB transceivers 186 may be provided at different locations of the vehicle 102 such as the rear-view mirrors, front/rear bumper, door panels or the like. Each of the plurality of UWB transceivers may be configured to individually or collectively communicate with one or more corresponding transceivers associated with a charging facility 202 (a.k.a. charging bay). The charging facility 202 may be associated with a plurality of chargers (a.k.a. charging stations) 204 each corresponding to a parking space 206 near the respective charging station 204.

In addition, one or more of the charging stations 204 may be associated with a charger UWB transceiver 208 configured to communicate with the corresponding vehicle UWB transceivers 186. The charger UWB transceiver 208 may be integrated with or separate from the respective charging stations 204. As illustrated in FIG. 2, the charging facility 202 may be affiliated with a first charging station 204a associated with a first charger UWB transceiver 208a. The charging facility 202 may be further affiliated with a second charging station 204b associated with a second charger UWB transceiver 208b. The charging facility 202 may be further affiliated with a third charging station 204c associated with a third charger UWB transceiver 208c. The charging facility 202 may be further affiliated with a fourth charging station 204d associated with a fourth charger UWB transceiver 208d. Each of the charger UWB transceivers 208 may be configured to individually or collectively communicate with the one or more vehicle UWB transceivers 186. Since UWB signals are transmitted at a high frequency, a precise timing of the signal received by and/or transmitted from each vehicle UWB transceiver 186 may be determined. Therefore, a relatively precise distance between the vehicle UWB transceivers 186 and the communicating charger UWB transceiver 208 may be determined or derived. Since the UWB transceivers 186 are located at different locations of the vehicle 102 each at a different distance from the communicating charger UWB transceiver 208, the orientation of the vehicle 102 relative to charging facility 202 may be determined by performing UWB signal triangulations to each of the vehicle UWB transceivers 186. For instance, each of the vehicle UWB transceivers 186 may be in communication with the third charger UWB transceiver 208c of the third charging station 204c that a vacant as illustrated with reference to FIG. 2. The first vehicle UWB transceiver 186a may be in a shortest distance from the third charger UWB transceiver 208c; the second vehicle UWB transceiver 186b may be in a second shortest distance from the third charger UWB transceiver 208c; the fourth vehicle UWB transceiver 186d may be in a third distance from the third charger UWB transceiver 208c; and the third vehicle UWB transceiver 186a may be in a longest distance from the third charger UWB transceiver 208c. The orientation of the vehicle 102 relative to the third charging station 204c may be determined using the above distance differences. Additionally or alternatively, the UWB signal triangulations may be performed by the vehicle 102 based on UWB communications between one or more of the vehicle UWB transceivers 186 a plurality of charger UWB transceivers 208 under essentially the same concept.

The orientation information may be useful for directing the vehicle 102 to the correct charging station 204 and parking space 206. Additionally or alternatively, the charger UWB transceivers 208 may be further configured to communicate with one or more wireless transceivers 142 of the mobile device 128 configured to support UWB communications. In case that the vehicle 102 does not support UWB communications, the charger UWB transceiver 208 may connect to the mobile device 128 to determine a distance between the charging station 204 and the vehicle 102. Signal triangulations may be made collectively using a plurality of charger UWB transceivers 208 to determine the location of the mobile device 128 which corresponds to the location of the vehicle 102. Additionally, if multiple mobile devices 128 are located in the vehicle 102 (e.g. associated with the driver and the passenger each), a single charger UWB transceiver 208 in communication with the multiple the mobile devices 128 at different location of the vehicle 102 may be configured to triangulate the UWB signals from the multiple mobile devices 128 and determine the orientation of the vehicle 102 relative of the associated charging station 204 through the triangulations. As illustrated in the example with reference to FIG. 2, the vehicle 102 may be associated with a driver mobile device transceiver 142a located on the driver side (i.e. left side) and a passenger mobile device transceiver 142b located on the passenger side which is farther from the charger UWB transceivers 208. One or more of the charger UWB transceivers 208 may determine the orientation of the vehicle using the distance difference between mobile devices transceivers 142a, 142b on the driver and passenger side respectively.

As illustrated in the example with reference to FIG. 2, while all other charging stations 204 are occupied, the third charging station 204c is still vacant. The vehicle 102 may be directed to the third charging station 204 using the UWB communications. In one example, the computing platform 104 may output driving instructions via the HMI controls 112 based on UWB signal triangulations discussed above. The HMI controls 112 may provide specific driving instruction to the user via the display 114 and speaker 118 such as “The third charging station is vacant. Drive slowly and turn left in X feet” wherein the value X is updated in a frequent manner. Additionally or alternatively, the ADC controller 182 may enable autonomous driving maneuvers to the correct parking space 206c once the vehicle 102 establishes the UWB communication with the corresponding charging station 204c. In addition to the UWB communications, the vehicle 102 may further use the sensor data to facilitate the autonomous maneuver at the charging facility 202. As discussed above, the vehicle 102 may be provided with parking assist features facilitated by cameras and parking sensors 184. The ADC 182 may combine UWB signals with the sensor data to enable an automatic parking to the correct parking space 206c.

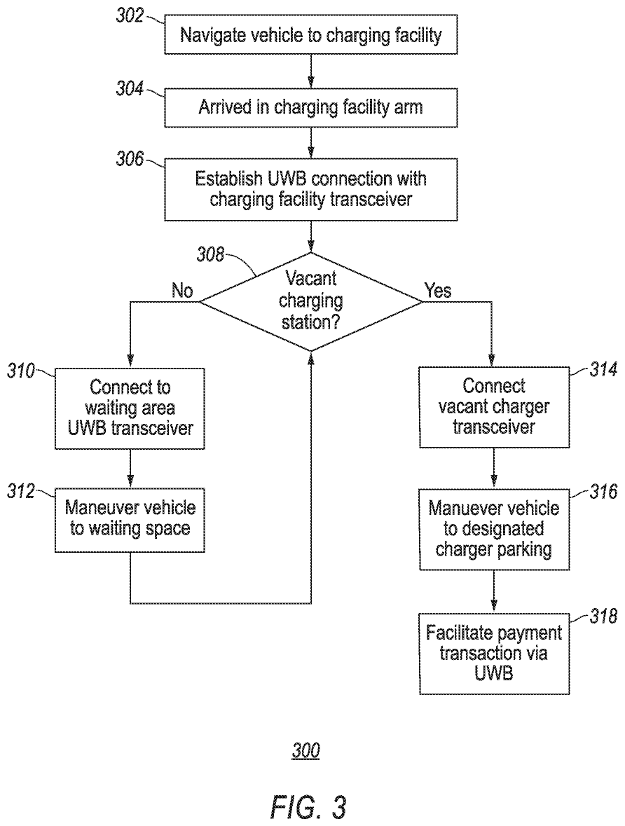

Referring to FIG. 3, an example flow diagram of a process 300 for operating the vehicle to a charging station of one embodiment of the present disclosure is illustrated. With continuing reference to FIGS. 1 and 2, the process 300 may be implemented via various components of the vehicle 102 individually or collectively. For simplicity purposes, the following description will be made with reference to the computing platform 104 and the ADC 182. It is noted that although the process 300 is describe in the context of electric vehicle charging, the present disclosure is not limited thereto. The process 300 may be applied to the context of refueling vehicles consuming other types of energy such as hydrogen, fossil fuel or the like. At operation 302, the computing platform 104 navigates the vehicle 102 to a charging facility 202 having at least one charging station 204. The navigation may be performed by the navigation controller 122 providing driving instructions to the driver via the HMI controls 112. Alternatively, the navigation signal may be provided to the ADC 182 to enable the vehicle 102 to autonomously drive to the charging facility without requiring driver input. At operation 304, responsive to arriving at the charging facility by detecting the vehicle 102 has entered a predefined geofence via the GNSS controller 124, the vehicle establishes UWB connections between one or more vehicle UWB transceivers 186 and a charging facility wireless transceivers configured to support UWB communications at operation 306. The identification of the charging facility wireless transceivers may be previously sent to the vehicle 102 when the navigation destination is set to facilitate the UWB communications upon arrival. The charging facility 202 may be provided a variety of UWB transceivers. For instance, in addition to the charger UWB transceiver 208 associated with each charging station 204, the charging facility 202 may be further provided with one or more generic/peripheral UWB transceivers (not shown) configured to cover the vicinity of the charging facility 202. The charging facility 202 may be further provided with one or more waiting area UWB transceivers (not shown) configured to cover one or more waiting area. Since charging electric vehicles may take a longer time compared with refueling a conventional fuel vehicle, the charging facility may be provided with waiting areas to allow the vehicle to park and wait until one of the charging stations 204 becomes available.

At operation 308, the computing platform 104 verifies if there is any vacant charging station 204 at the charging facility 202. The verification may be made by the UWB communication between the vehicle and the charging facility. If the answer is No, the process proceeds to operation 310 and the vehicle UWB transceivers 186 connects to one or more waiting area UWB transceivers (if they are not currently connected). At operation 312, the computing platform 104 directs the vehicle driver to park at a waiting parking space using the vehicle location and orientation information determined by the UWB communications. Additionally or alternatively, the ADC 182 of the vehicle 102 may autonomously maneuver the vehicle 102 to the designated parking area with or without the help of the sensor data discussed above. In some cases, the plurality of vehicle UWB transceivers 186 alone may be sufficient to allow the vehicle 102 and/or the charging facility 202 to perform the signal triangulation and determine/derive the vehicle location and orientation. However, in case that one or more user mobile devices 128 supporting UWB communications is connected to the vehicle 102, the UWB signals from the mobile device 128 may enable a more precise determination by the computing platform 104. While waiting at the waiting area, the computing platform 104 continuously verifies if a charging station 204 has become available.

If the computing platform 104 detects a charging station 204 has become available, the process proceeds to operation 314 and the vehicle 102 establish the UWB connections with the charger UWB transceiver 208 associated with the vacant charging station 204. The UWB connections may be directly established if the waiting area that the vehicle 102 is currently parked is within the transmission distance from the charger UWB transceiver 208. Otherwise, the computing platform 104 continues to communicate with the waiting area UWB transceiver until the vehicle 102 is driven closer to the charging station and the UWB connection with the charger UWB transceiver 208 has been established to enable a seamless transition from the parking area to the charging area. At operation 316, the vehicle 102 maneuvers to the designed parking space associated with the vacant charging station. Similar to operation 312, the ADC 182 may autonomously maneuver the vehicle 102 without requiring driver input. Here, although having the driver within the vehicle is preferred, the ADC 182 may perform the autonomous maneuver without requiring the driver to be in the vehicle. Additionally or alternatively, the computing platform 104 may send a message to the mobile device 128 of the user to ask the user to manually drive the vehicle 102 to the vacant charging station 204 identified. Responsive to arriving at the designated parking space 206 associated with the charging station 204, at operation 318, the computing platform 104 performs a payment transaction with the charging station 204 using the UWB connection that is already established with the corresponding charging station 204.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of the disclosure. The words processor and processors may be interchanged herein, as may the words controller and controllers.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle, comprising:
a plurality of vehicle transceivers; and
a controller, programmed to:
responsive to detecting the vehicle has arrived at a predefined geofence associated with a charging facility, establish a first ultra-wide band (UWB) communication between the plurality of vehicle transceivers and a charger transceiver associated with a charger,
calculate an orientation and distance of the charger from the vehicle using a timing of the first UWB communication of each of the plurality of vehicle transceivers, and
maneuver the vehicle to a parking space associated with the charger based on the first UWB communication without driver input.

2. The vehicle of claim 1, wherein the controller is further programmed to:
responsive to detecting the charger is occupied, establish a second UWB communication between the plurality of vehicle transceivers and a waiting transceiver associated with a waiting area, and
maneuver the vehicle to the waiting area based on the second UWB communication without the driver input.

3. The vehicle of claim 2, wherein the controller is further programed to:
responsive to receiving a signal indicative of the charger has become available while parked at the waiting area, maneuver the vehicle from the waiting area to the parking space based on both the first UWB communication and the second UWB communication.

4. The vehicle of claim 2, wherein the controller is further programmed to responsive to receiving a signal indicative of the charger has become available while parked at the waiting area, send a message to a mobile device associated with a vehicle user, wherein the message identifies the charger.

5. The vehicle of claim 1, wherein the vehicle is further in communication with a mobile device having a UWB connection with the charger transceiver, the controller is further programmed to:
calculate the orientation and distance of the charger from the vehicle further using data representative of timing of the UWB connection between the mobile device and the charger transceiver.

6. The vehicle of claim 1, further comprising:
a sensor configured to detect an object at a predefined vicinity of the vehicle; and
the controller is further programmed to:
maneuver the vehicle to the parking space associated with the charger based on the first UWB communication and data received from the sensor without driver input.

7. The vehicle of claim 6, wherein the sensor includes a lidar sensor and a camera.

8. The vehicle of claim 1, wherein the controller is further programmed to communicate payment data with the charger via the first UWB communication.

9. A method for a vehicle, comprising;
responsive to setting a charging facility as navigation destination, receiving an identification of a charger transceiver associated with a charger;
responsive to establishing a first ultra-wide band (UWB) communication between a plurality of vehicle transceivers and the charger transceiver, calculating a distance of the charger from the vehicle using a timing of the first UWB communication of each of the plurality of vehicle transceivers; and
maneuvering the vehicle to a parking space associated with the charger based on the first UWB communication without a driver input.

10. The method of claim 9, further comprising:
responsive to detecting the charger is occupied, establishing a second UWB communication between the plurality of vehicle transceivers and a waiting transceiver associated with a waiting area, and
maneuvering the vehicle to the waiting area based on the second UWB communication without the driver input.

11. The method of claim 10, further comprising:
responsive to receiving a signal indicative of the charger has become available while parked at the waiting area, maneuvering the vehicle from the waiting area to the parking space based on both the first UWB communication and the second UWB communication.

12. The method of claim 10, further comprising:
responsive to receiving a signal indicative of the charger has become available while parked at the waiting area, sending a message to a mobile device associated with a vehicle user, wherein the message identifies the charger.

13. The method of claim 9, further comprising:
communicating with a mobile device having a UWB connection with the charger transceiver; and
calculating the distance of the charger from the vehicle further using data representative of timing of the UWB connection between the mobile device and the charger transceiver.

14. The method of claim 9, further comprising:
detecting an object at a predefined vicinity of the vehicle via a sensor; and
maneuvering the vehicle to the parking space associated with the charger based on the first UWB communication and data received from the sensor without driver input.

15. The method of claim 9, further comprising:
responsive to detecting the vehicle has arrived a predefined geofence associated with a charging facility, establishing the first UWB communication.

16. A non-transitory computer readable medium, comprising instructions that, when executed by a vehicle, cause the vehicle to perform operations including to:
responsive to establishing a first ultra-wide band (UWB) communication between a plurality of vehicle transceivers and a charger transceiver of a charger, calculate a direction and distance of the charger from the vehicle using a timing of the first UWB communication of each of the plurality of vehicle transceivers; and
maneuvering the vehicle to a parking space associated with the charger based on the first UWB communication.

17. The non-transitory computer readable medium of claim 16, further comprising instructions that, when executed by the vehicle, cause the vehicle to perform operations including to:
responsive to setting a charging facility as navigation destination, receive an identification of a charger transceiver associated with a charger; and
responsive to detecting the vehicle has arrived a predefined geofence associated with a charging facility, establish the first UWB communication using the identification.

18. The non-transitory computer readable medium of claim 16, further comprising instructions that, when executed by the vehicle, cause the vehicle to perform operations including to:
responsive to detecting the charger is occupied, establish a second UWB communication between the plurality of vehicle transceivers and a waiting transceiver associated with a waiting area; and
maneuver the vehicle to the waiting area based on the second UWB communication.

19. The non-transitory computer readable medium of claim 18, further comprising instructions that, when executed by the vehicle, cause the vehicle to perform operations including to:
responsive to receiving a signal indicative of the charger has become available while parked at the waiting area, maneuver the vehicle from the waiting area to the parking space based on both the first UWB communication and second UWB communication.

20. The non-transitory computer readable medium of claim 16, further comprising instructions that, when executed by the vehicle, cause the vehicle to perform operations including to:
communicate with a mobile device having a UWB connection with the charger transceiver; and
calculate the direction and distance of the charger from the vehicle further using data representative of timing of the UWB connection between the mobile device and the charger transceiver.
